(19) United States
(12) Patent Application Publication
(10) Pub. No.: US 2009/0315500 A1
(43) Pub. Date: Dec. 24, 2009

(54) Control Device for Setting and Controlling Movement of Table of Milling Machine

(76) Inventor: Yu-Ching Chiang, Taoyuan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/141,164

(22) Filed: Jun. 18, 2008

(51) Int. Cl. G05B 19/19

(52) U.S. Cl. 318/568.1

(57) ABSTRACT

A control device for setting and controlling movement of a table of a milling machine includes an operative switch operable to make a central processor output pulse signals to drive a servomotor for moving the table to a plurality of processing positions in sequence. An analogue/digital converter includes an input end receiving analogue signals and outputs digital signals containing pulse wave amount data indicative of the movement of the table to each processing position. The central processor receives the digital signals from the analogue/digital converter. A memory setter is operable to make the register store the pulse wave amount data indicative of the movement of the table to the processing positions in sequence. A position access button is operable to make the central processor output pulse signals containing the pulse wave amount data indicative of the processing positions to the servomotor, moving the table to the processing positions in sequence.

### BACKGROUND OF THE INVENTION

The present invention relates to a control device for a milling machine and, more particularly, to a control device for setting and controlling movement of a table of a milling machine.

Milling machines are widely utilized to mill various workpieces to obtain planar faces, curved faces, angled portions, gears, holes, grooves, cams, etc. and capable of achieving high yield at high speed through change of cutters. A typical milling machine includes a frame mounted on the ground and a table slideably mounted on the frame. The table is driven by a power device such as an electric motor to move reciprocatingly on the frame so that a workpiece placed on the table can be milled by cutters mounted on a turret located above the table. In practice, a worker operates the electric motor to move the table and the workpiece to a processing position for a first milling operation. After the first milling operation, the worker operates the electric motor again to move the table and the workpiece to the next processing position where a second milling operation is carried out. The procedure is repeated until all necessary milling operations are carried out on the workpiece. The milling operations are time-consuming and increase the costs when there are many processing positions (e.g., the number of the holes and grooves to be processed is large). The problem is aggravated if a large number of workpieces is involved. In addition, operating mistakes are liable to occur, leading to adverse effect to processing quality and accuracy.

### BRIEF SUMMARY OF THE INVENTION

A control device for a milling machine according to the preferred teachings of the present invention is utilized to set and control movement of a table of a milling machine that has a screw rod connected to the table and a servomotor operably connected to the screw rod for moving the table. The control device includes a central processor having an input end, an output end, and a register. An operative switch is electrically connected to the central processor and operable to make the central processor output pulse signals to drive the servomotor, moving the table to a plurality of processing positions in sequence. An analogue/digital converter includes an input end receiving analogue signals indicative of movement of the table to each processing position through operation of the operative switch. The analogue/digital converter outputs digital signals containing pulse wave amount data indicative of the movement of the table to each processing position. The input end of the central processor receives the digital signals from the analogue/digital converter. A memory activating switch is electrically connected to the central processor and operable to make the register begin storage of the pulse wave amount data contained in the digital signals indicative of the processing positions. A memory setter is electrically connected to the central processor and operable to make the register store the pulse wave amount data indicative of the movement of the table to the processing positions in sequence. A memory ending button is electrically connected to the central processor and operable to end storage of the pulse wave amount data by the register. A position access button is electrically connected to the central processor and operable to make the output end of the central processor output pulse signals containing the pulse wave amount data indicative of the processing positions to the servomotor, moving the table to the processing positions in sequence.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a diagrammatic side view of a milling machine utilizing a control device according to the preferred teachings of the present invention.

FIG. 2 shows a partial, perspective view of the milling machine of FIG. 1.

FIG. 3 shows a perspective view of a control box of the milling machine of FIG. 1 with a wall of the control box removed to show an interior of the control box.

FIG. 4 shows a block diagram illustrating main components of the control device according to the preferred teachings of the present invention.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

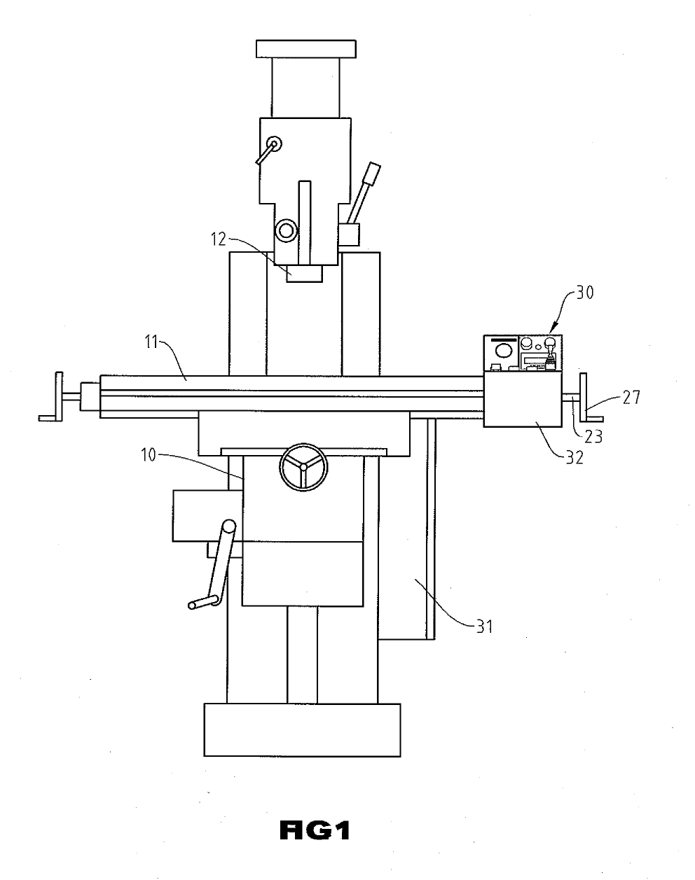

FIG. 1 shows a milling machine utilizing a control device according to the preferred teachings of the present invention. Milling machine includes a frame 10, a table 11 slideably mounted to frame 10, and a turret 12 mounted above table 11. A plurality of cutters are mounted on turret 12 for milling a workpiece placed on table 11. The control device according to the preferred teachings of the present invention is utilized to set and control movement of table 11.

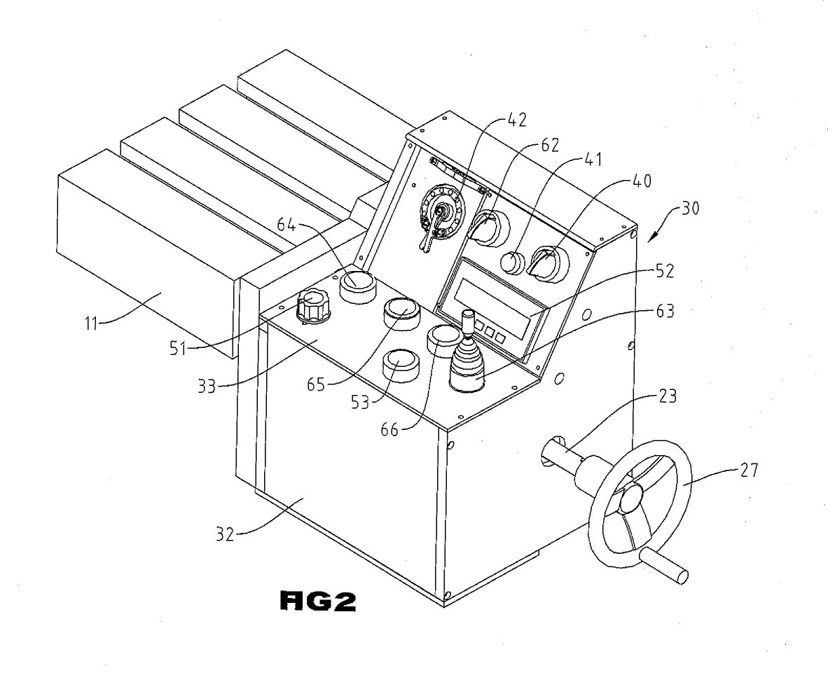

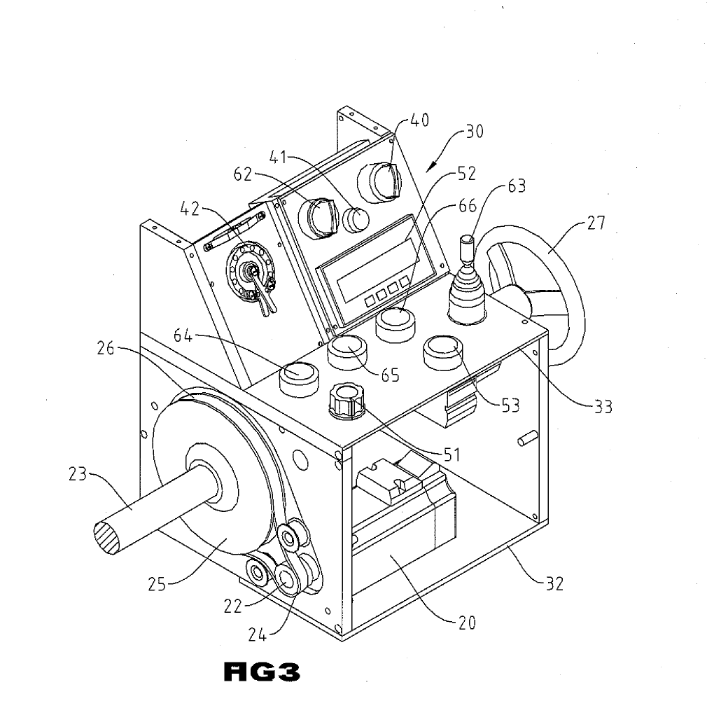

According to the preferred form shown, an AC servomotor 20 and a control box 30 for receiving servomotor 20 are mounted at a side of table 11 to which a screw rod 23 is attached (FIGS. 2 and 3). Servomotor 20 includes an output shaft 22 connected to screw rod 23 via a transmission device in the most preferred form shown including a pulley 24 mounted around output shaft 22 to turn therewith, a pulley 25 mounted around screw rod 23 to turn therewith, and a belt 26 mounted around pulleys 24 and 25. Other forms of the transmission device would be within the skill of the art. An end of screw rod 23 is extended through control box 30 and coupled with a hand wheel 27 for manually rotating screw rod 23. Thus, table 11 can be moved by servomotor 20 or hand wheel 27.

Control box 30 includes a hollow box body 32 and a panel 33 on which a power switch (including emergency power-break function) 40 and an indicator lamp 41 indicating on/off state of power switch 40 are mounted. Also mounted on panel 33 are a travel setting device 42 for setting left/right travel limit of table 11, a speed adjuster 51 for adjusting the speed of table 11, a speed display 52 showing the speed of table 11, and a rapid feeding switch 53 for increasing the speed of servomotor 20. Travel setting device 42 cuts off power when table 11 reaches the left travel limit or the right travel limit.

According to the preferred form shown, the control device according to the preferred teachings of the present invention includes an analogue/digital converter 50, a central processor (or a programmable controller) 60, a memory activating switch 62, an operative switch 63, a memory setter 64, a memory ending button 65, and a position access button 66. Central processor 60 outputs pulse signals to control servomotor 20 via a servo controller 21. Memory activating switch 62, operative switch 63, memory setter 64, memory ending button 65, and position access button 66 are mounted on panel 33. Analogue/digital converter 50 and servo controller 21 are mounted in a box 31 (FIG. 1) below table 11.

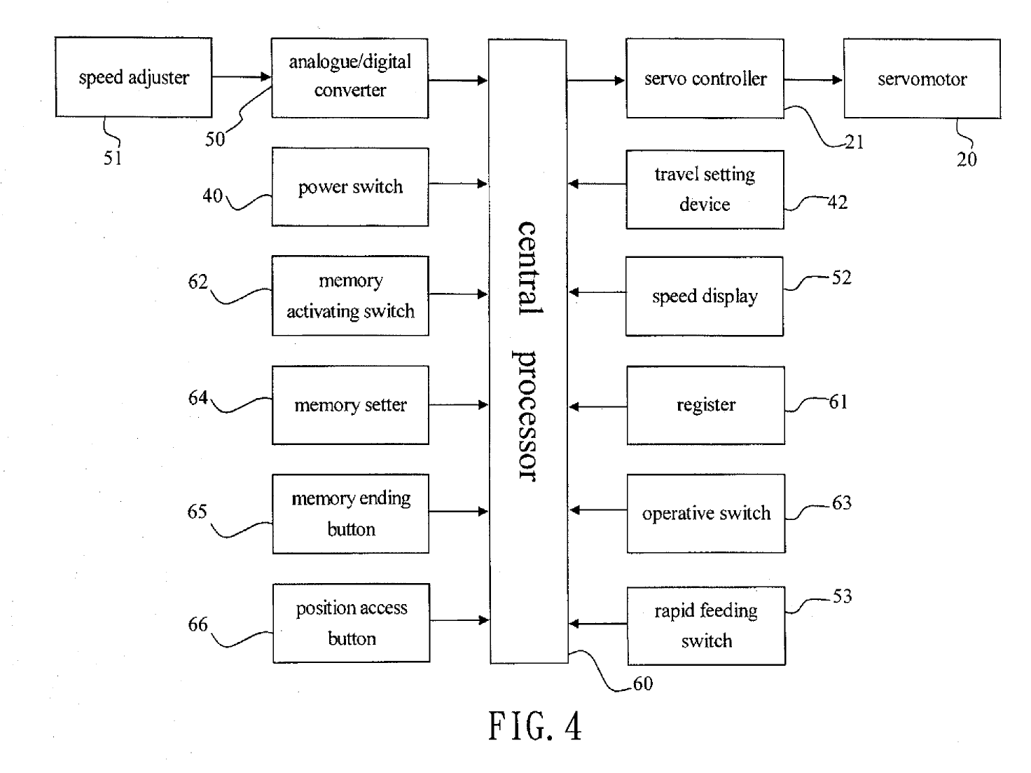

With reference to FIGS. 2, 3, and 4, analogue/digital converter 50 has an input end receiving analogue signals and outputs digital signals converted from the analogue signals. Speed adjuster 51 is electrically connected to the input end of analogue/digital converter 50 and allows adjustment of power voltage by varying resistance to control the speed of servomotor 20. Central processor 60 includes an input end receiving digital signals from analogue/digital converter 50 and an output end outputting pulse signals to control the displacement and moving direction of table 11 by utilizing plus sign and minus sign. Central processor 60 further includes a register 61 for storing pulse wave amount data that is set to be in a range from 0 to 2000. Memory activating switch 62 is electrically connected to central processor 60, and register 61 is activated to begin storage of the pulse wave amount data when memory activating switch 62 is turned on. Operative switch 63 is electrically connected to central processor 60 to control pulse signal output of central processor 60 for driving servomotor 20 through servo controller 21. Memory setter 64 is electrically connected to central processor 60 to make register 61 store pulse wave amount data indicative of movement of table 11 to a corresponding processing position by each pressing of memory setter 64. Memory ending button 65 is electrically connected to central processor 60 to end storage of the pulse wave data indicative of the processing positions by register 61. Position access button 66 is electrically connected to central processor 60. Central processor 60 outputs pulse signals containing the pulse wave amount data indicative of corresponding processing positions through servo controller 21 to servomotor 20 to move table 11 to the corresponding processing positions in sequence by pressing position access button 66.

The control device according to the preferred teachings of the present invention is suitable to control milling of a large number of workpieces by memorizing each processing position of the workpieces. In setting, memory activating switch 62 is turned on, and operative switch 63 is manually operated to move table 1 to a first processing position. Memory setter 64 is pressed to send a first pulse wave amount data indicative of the first processing position to register 61. Namely, first pulse wave amount data indicative of the first processing position is stored in register 61. Operative switch 63 is manually operated again to move table 1 to a second processing position. Memory setter 64 is pressed again to store a second pulse wave amount data indicative of the second processing position in register 61. Plus or minus increment of the second pulse wave amount data is based on the first pulse wave amount data. By repeating the above procedures, third, fourth, fifth or even up to one-thousandth pulse wave amount data indicative of corresponding processing positions can be set (or stored) in register 61. Memory storage ends when memory ending button 65 is pressed.

When milling a first workpiece, memory activating switch 62 is turned on, and position access button 66 is pressed, causing central processor 60 to access the first pulse wave amount data in register 61 and outputs a pulse signal indicative of the first processing position to servomotor 20 via servo controller 21. Thus, table 11 is moved to the first processing position where the first milling operation is carried out. Next, position access button 66 is pressed again, causing central processor 60 to access the second pulse wave amount data in register 61 and outputs a pulse signal indicative of the second processing position to servomotor 20 via servo controller 21. Thus, table 11 is moved to the second processing position where the second milling operation is carried out. By repeating the above procedures, all processing operations of the first workpiece can be carried out one by one, and milling operation of the next workpiece can be carried out in the same way.

The control device according to the preferred teachings of the present invention is suitable to control milling of a large number of workpieces by memorizing the processing positions of the workpieces one by one and then carrying out milling operations one by one through simple manual operations. The processing efficiency and processing accuracy of the workpieces are largely improved, the overall processing time is saved, and the manufacturing costs are cut.

Thus since the invention disclosed herein may be embodied in other specific forms without departing from the spirit or general characteristics thereof some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A control device for setting and controlling movement of a table of a milling machine, with the milling machine including a screw rod connected to the table and a servomotor operably connected to the screw rod for moving the table, with the control device comprising:
a central processor including an input end, an output end, and a register;
an operative switch electrically connected to the central processor and operable to make the central processor output pulse signals to drive the servomotor, moving the table to a plurality of processing positions in sequence;
an analogue/digital converter including an input end receiving analogue signals indicative of movement of the table to each of the plurality of processing positions through operation of the operative switch, with the analogue/digital converter outputting digital signals containing pulse wave amount data indicative of the movement of the table to each of the plurality of processing positions, with the input end of the central processor receiving the digital signals from the analogue/digital converter;
a memory activating switch electrically connected to the central processor and operable to make the register begin storage of the pulse wave amount data contained in the digital signals indicative of the plurality of processing positions;
a memory setter electrically connected to the central processor, with the memory setter being operable to make the register store the pulse wave amount data indicative of the movement of the table to the plurality of processing positions in sequence;
a memory ending button electrically connected to the central processor and operable to end storage of the pulse wave amount data by the register; and
a position access button electrically connected to the central processor and operable to make the output end of the central processor output pulse signals containing the pulse wave amount data indicative of the plurality of processing positions to the servomotor, moving the table to the plurality of processing positions in sequence.

2. The control device as claimed in claim 1, further comprising, in combination: a control box to which the memory activating switch, the operative switch, the memory setter, the memory ending button, and the position access button are mounted.

3. The control device as claimed in claim 2, further comprising, in combination: a speed adjuster electrically connected to the input end of the analogue/digital converter for adjusting a power voltage to control speed of the servomotor.

4. The control device ad claimed in claim 3, with the control box being mounted at a side of the table and receiving the speed adjuster.
